(19) United States
(12) Patent Application Publication
(10) Pub. No.: US 2025/0172042 A1
(43) Pub. Date: May 29, 2025

(54) COMBINATION LADDER AND HINGE MECHANISM

(71) Applicant: Tricam Industries, Inc., Eden Prairie, MN (US)

(72) Inventors: Joseph P. Foley, Mendota Heights, MN (US); Benjamin M. Wernberg, Savage, MN (US); Benjamin P. Williams, Chaska, MN (US)

(73) Assignee: Tricam Industries, Inc., Eden Prairie, MN (US)

(21) Appl. No.: 18/962,701

(22) Filed: Nov. 27, 2024

Related U.S. Application Data
(60) Provisional application No. 63/603,218, filed on Nov. 28, 2023.

(51) Int. Cl. E06C 7/50; E06C 1/32; E06C 1/39; E06C 7/00; E06C 7/16; F16C 11/10

(52) U.S. Cl. CPC E06C 7/50; E06C 1/32; E06C 7/003; F16C 11/10; E06C 1/39; E06C 7/16

(57) ABSTRACT

A combination ladder with a hinge mechanism that utilizes a single latch bar to activate a pair of hinges to allow the ladder to lock into folded, A-frame, and extension ladder positions. The latch mechanism and hinge are located adjacent to the convertible ladder top cap to maximize the ladder length when in the extension position.

### FIELD OF THE INVENTION

The present disclosure relates generally to multi-position ladders, and more particularly to a combination ladder that can in folded, A-frame, or extension positions with a hinge latch mechanism that utilizes a latch bar for locking and unlocking the ladder from one of its positions.

### BACKGROUND OF THE INVENTION

Portable ladders are commonly used for a variety of applications, with several different styles being widely used. The two best known designs are extension ladders, which must be leaned against a vertical surface for support, and A-frame or step ladders, which are free standing. For some time, it has been known that constructing ladders with two sections that are slidably mounted with respect to each other enables the overall length of the extension ladder to be varied depending upon the desired use of the extension ladder. This feature is particularly useful for transporting the ladder to a desired use location. However conventional extension ladders do not have the ability to stand up without being leaned against another object. In certain circumstances it is not possible to lean the extension ladder against other objects.

To overcome this shortcoming, Kummerlin et al., U.S. Pat. No. 3,692,143, pivotally attaches two extension ladders together. This ladder retained the benefits of being able to adjust the height of the ladder while adding the benefit that the ladder could remain erect without leaning against other objects. Kummerlin et al. is incorporated herein in its entirety by reference. Multi-position ladders have become very popular in recent years because of their versatility and are being used for a variety of applications by members of the construction trade, maintenance personnel, and homeowners, among others. Many improvements have been made to the design of multi-position ladders. Simpson et al., U.S. Pat. No. 6,857,503, s entirety by reference, is directed to a multi-position ladder that is versatile, light weight, and relatively low in cost. A common element of most multi-purpose ladders is the hinge assembly, which enables the adjustability of the ladder's position while also contributing to its stability while in a working position. Another example of a combination ladder that provides both A-frame and extension ladder positions is disclosed by Mayfield et al., U.S. Pat. No. 11,441,356, incorporated herein in its entirety by reference. Mayfield et al, is directed to a combination ladder that has a self-supporting position and an extension position.

Accordingly, many improvements have been made to the design of the hinge components of multi-position ladders. U.S. Pat. Nos. 4,407,045 and 4,566,150, to Boothe, are both directed to a hinge for an articulating ladder. The hinge includes two hinge plates that are pivotally attached with a central hub. Pivoting of the hinge plates is controlled with a locking handle that extends through apertures in the hinge plates. The locking handle is biased to a locking position where the legs on the locking handle extend into the hinge plate apertures. Most hinges on adjustable ladders generally include a locking handle that secures the sections of the ladder in place when in use, and a spring-loaded actuator that is used by the operator to disengage the locking handle in order to adjust the position of the hinge, and accordingly the position of the ladder. Lee et al., U.S. Pat. No. 6,711,780, is directed at a concealed spring within the locking mechanism to prevent the hands or gloves of an operator from becoming jammed in the spring when the press part is pressed. An alternative to the press-part design of adjustable ladder hinges utilizes a locking cam. Sheng, U.S. Pat. No. 5,620,272, is directed toward hinge design that utilizes a locking rod and a coupling disc containing a plurality of holes in various positions to enable hinge position adjustment. Purkapile, U.S. Pat. No. 4,773,503, is directed at a hinge that employs circular teeth on mating faces of the adjustable hinge and a cam lock, offering the ability for the hinge to assume a greater number of adjustable positions than that available with prior designs. Each of the aforementioned patents is incorporated herein in its entirety by reference.

When selecting a multi-purpose ladder for use or purchase, users may consider many factors including product cost, ladder weight, ease of use, and safety. In particular, the ease of use for a multi-position ladder pertains to the ease of adjustability for its hinges, and the speed at which the hinges can be adjusted for repositioning. For users of multi-position ladders in the construction and crafts trades, where the multi-position is used extensively in their work, it may be cumbersome to operate the adjustment features on popular hinge styles that require pushing inward on the press part from the outside of the ladder on each side of to disengage the locking handle, particularly when the ladder is being used in a confined space. Further, most multi-position ladders require unlocking of each hinge separately. Thus, there is an ongoing challenge for convertible ladders to have a locking mechanism that allows for easier single activation and use while also providing a robust hinge that will keep the ladder locked in the desired position. The present disclosure addresses these concerns.

### SUMMARY OF THE INVENTION

Embodiments of the present disclosure provide an improved combination ladder, hinge, and locking mechanism. In one embodiment a front frame and a rear frame are connected by a pair of hinges adjacent to the top cap of the ladder. The rear frame is rotatable about the hinge from a folded (stored/transport) position, to an A-frame (stand alone) position, to an extension (supported by other structure) ladder position. The location of the hinge adjacent the top cap allows the ladder to provide additional length when the ladder is in the extension ladder position compared to prior art convertible ladders. Another embodiment has a hinge latch mechanism that locks and unlocks both hinges simultaneously with one motion. A further embodiment has an indicator that allows a user to easily see if the latch mechanism is in its locked or unlocked position. Another embodiment has a guide for the latch mechanism that eliminates slop and play in the hinge mechanism while providing a secure hinge lock that is easy to use.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

FIG. 1 is a perspective front right view of a combination ladder in an A-frame position according to an embodiment of the present invention.

FIG. 2 is a front elevation view of the combination ladder of FIG. 1.

FIG. 3 is a rear elevation view of the combination ladder of FIG. 1.

FIG. 4 is a right side elevation view of the combination ladder of FIG. 1.

FIG. 5 is a left side elevation view of the combination ladder of FIG. 1.

FIG. 6 is a top plan view of the combination ladder of FIG. 1.

FIG. 7 is a bottom plan view of the combination ladder of FIG. 1.

FIG. 8 is a cross-sectional view taken along the line A-A in FIG. 6.

FIG. 9 is a right side elevation view of the combination ladder of FIG. 1 in an extension position.

FIG. 10 is a right side elevation view of the combination ladder of FIG. 1 in a folded position.

FIG. 11 is a detail view of the area indicated by circle B in FIG. 4.

FIG. 12 is a detail view of the area indicated by circle C in FIG. 9.

FIG. 13 is a detail view of the area indicated by circle D in FIG. 10.

FIG. 14 is a perspective bottom right view of a combination ladder of the ladder of FIG. 1 with the hinge latch mechanism in the locked position with the right rear rail omitted.

FIG. 15 is a detail view of the area indicated by circle E in FIG. 14.

FIG. 16 is a perspective bottom right view of a combination ladder of the ladder of FIG. 1 with the hinge latch mechanism in the unlocked position with the right rear rail omitted.
FIG. 17 is a detail view of the area indicated by circle F in FIG. 16.

FIG. 18 is a right side elevation view of a rear hinge plate of the combination ladder of FIG. 1.

FIG. 19 is a detail view of the area indicated by circle G in FIG. 18.

FIG. 20 is a detail view of the area indicated by circle H in FIG. 18.

FIG. 21 is a right side elevation partial section view of the hinge latch mechanism of FIG. 1.

FIG. 22 is a perspective view of a latch spring guide according to an embodiment of the present invention. FIG. 23 is a front elevation view of the latch spring guide of FIG. 22.

FIG. 24 is a rear elevation view of the latch spring guide of FIG. 22.

FIG. 25 is a right side elevation view of the latch spring guide of FIG. 22.

FIG. 26 is a left side elevation view of the latch spring guide of FIG. 22.

FIG. 27 is a top plan view of the latch spring guide of FIG. 22.

FIG. 28 is a bottom plan view of the latch spring guide of FIG. 22.

FIG. 29 is a perspective view of a latch spring coupler according to an embodiment of the present invention.

FIG. 30 is a right side elevation view of the latch spring coupler of FIG. 29.

FIG. 31 a cross-sectional perspective view of the latch spring coupler taken along the line B-B in FIG. 30.

FIG. 32 is a left side elevation view of the latch spring coupler of FIG. 29.

FIG. 33 is a front elevation view of the latch spring coupler of FIG. 29.

FIG. 34 is a rear elevation view of the latch spring coupler of FIG. 29.

FIG. 35 is a top plan view of the latch spring coupler of FIG. 29.

FIG. 36 is a bottom plan view of the latch spring coupler of FIG. 29.

FIG. 37 is a perspective view of a latch bar according to an embodiment of the present invention.

FIG. 38 is a left side elevation view of the latch bar of FIG. 37.

FIG. 39 is a perspective view of a latch bar guide according to an embodiment of the present invention.

FIG. 40 is a right side elevation view of the latch bar guide of FIG. 39.

FIG. 41 is a left side elevation view of the latch bar guide of FIG. 39.

FIG. 42 is a rear elevation view of the latch bar guide of FIG. 39.

FIG. 43 is a front elevation view of the latch bar guide of FIG. 39.

FIG. 44 is a top plan view of the latch bar guide of FIG. 39.

FIG.45 is a bottom plan view of the latch bar guide of FIG. 39

While the various embodiments of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the inventions as may be claimed.

### DETAILED DESCRIPTION OF THE PREFERRED EMBODIMENTS

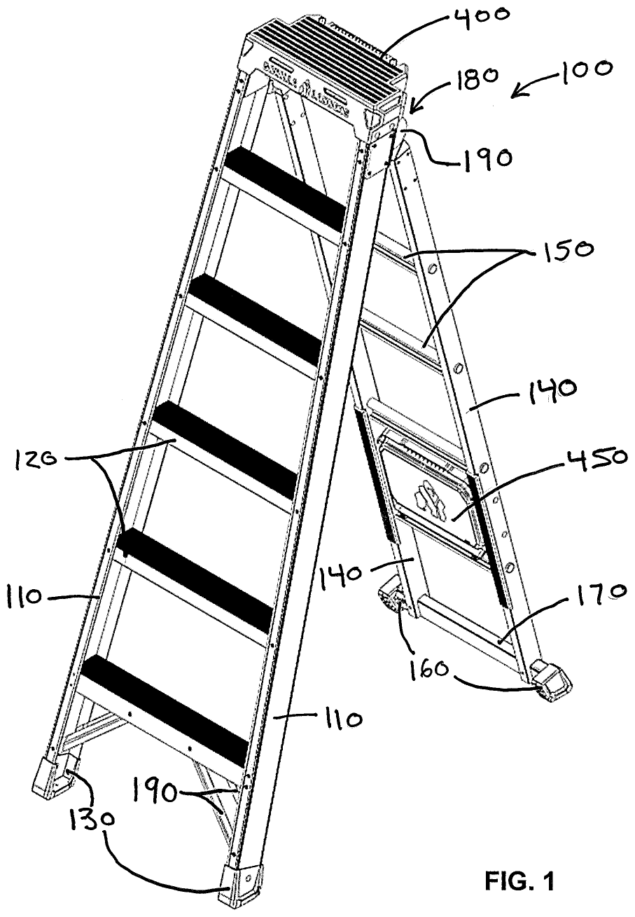

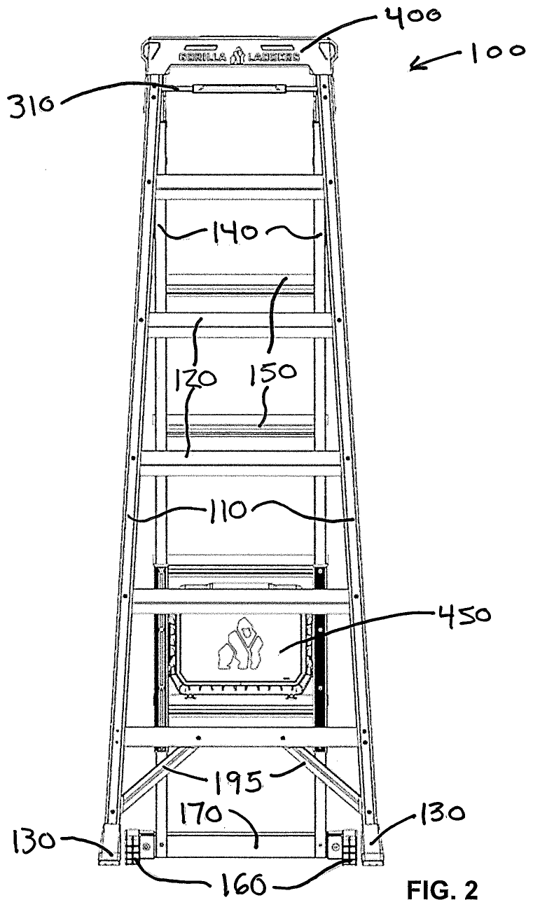

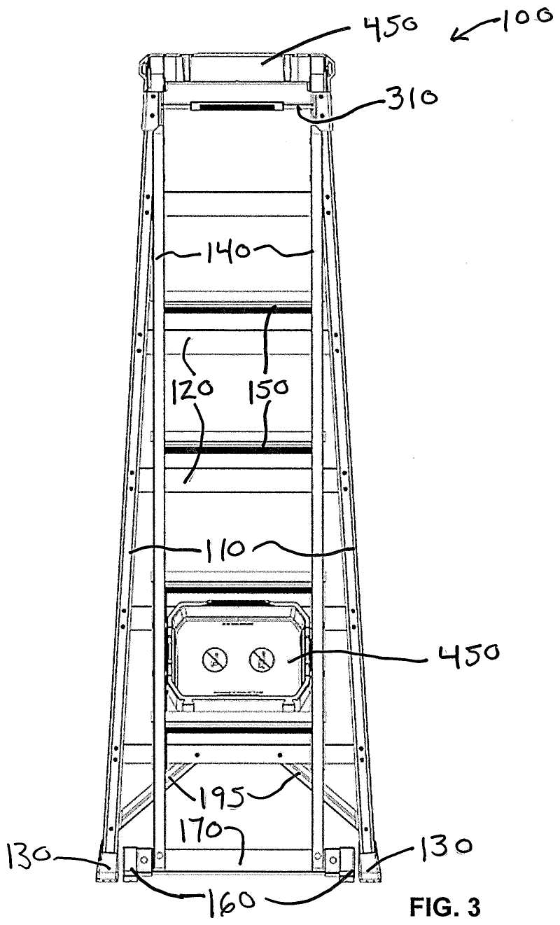

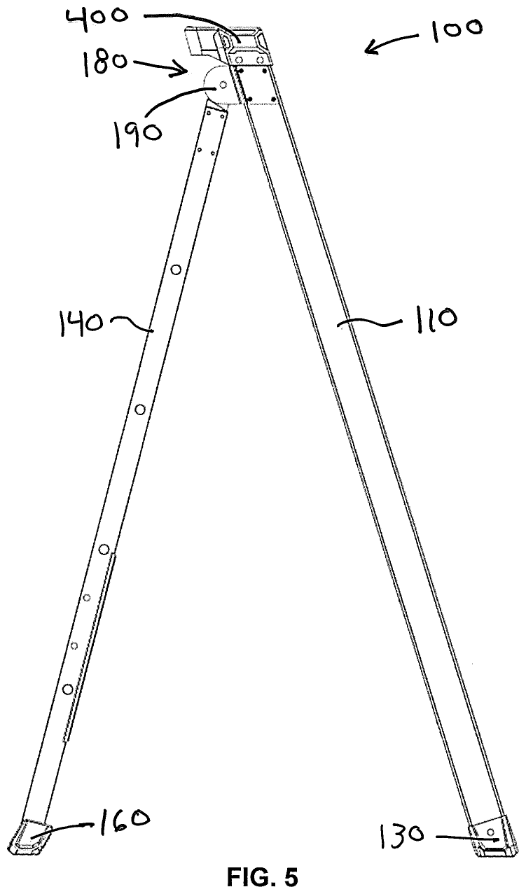

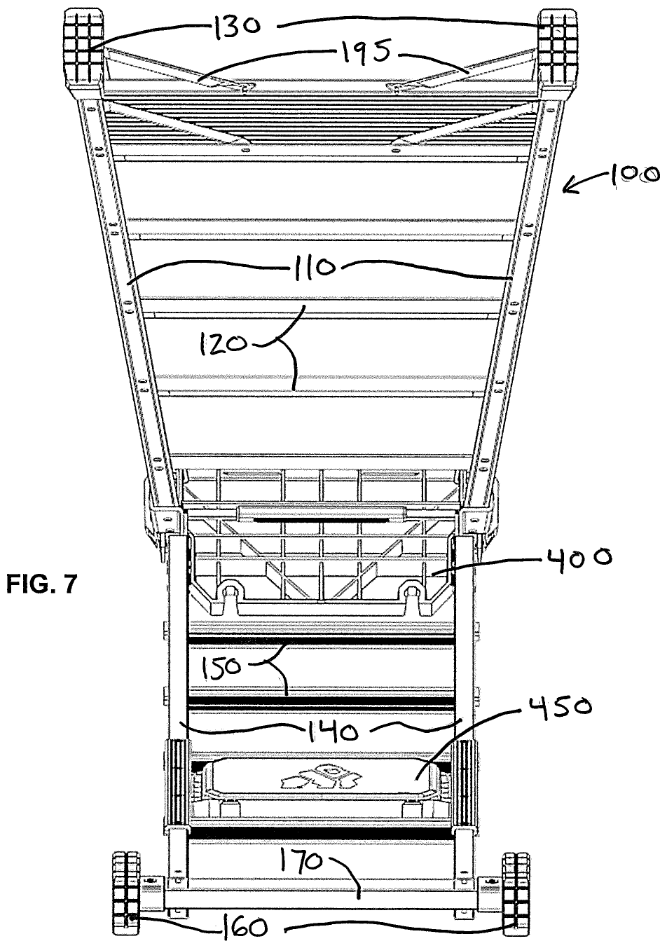

The present invention is a combination ladder, as most clearly illustrated at 100 in FIGS. 1-8. The combination ladder 100 includes a pair of front rails 110 spanned by a series of front steps 120 connected by a pair of hinges 180 to a pair of rear rails 140 spanned by a series of rear rail rungs 150. The invention may include a top cap 400, preferably attached to the top of the pair of front rails 110, above and adjacent to the pair of hinges 180.

The combination ladder 100 of the present invention may preferably include additional features to improve the functionality of the ladder 100 including front rail feet 130, rear rail feet 160, braces 190, and crossbars 170. The combination ladder 100 also preferably includes a storable bucket tray 450 similar to that disclosed by U.S. Patent Publication No. US 20210246725-A1 to Wernberg at al. The bucket tray 450 can be attached to the top cap 400 via bucket tray prongs 457 on the bucket tray 450 that fit into corresponding prong receivers 405 on the top cap 400. The bucket tray 450 is also storable between either the pair of front rails 110 or pair of rear rails 140 by means of storage rivets 140 on a pair of rails 110, 140 that fit into corresponding storage notches 455 on the bucket tray 450. Preferably the storage rivets 140 are placed on the pair of rear rails 140 to prevent interference with using the front steps 120 when the ladder 100 is in the A-frame position.

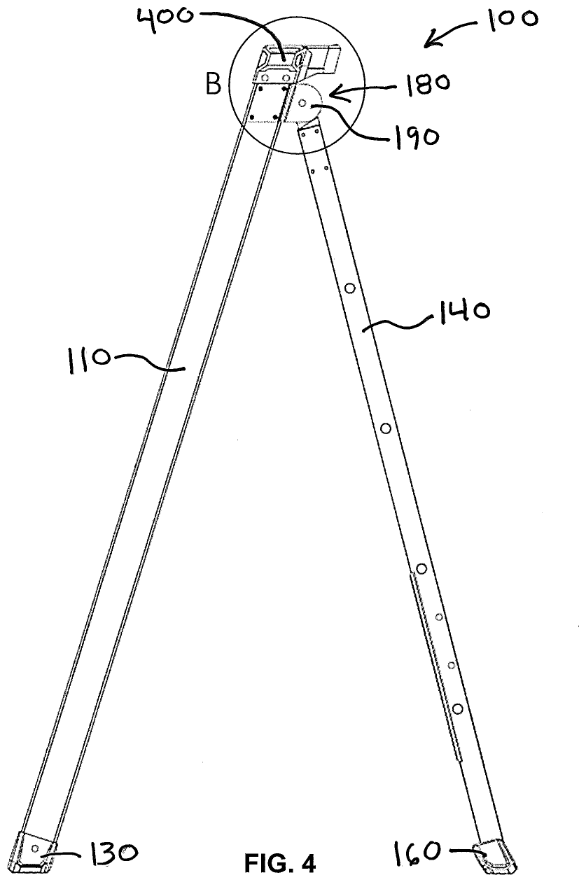

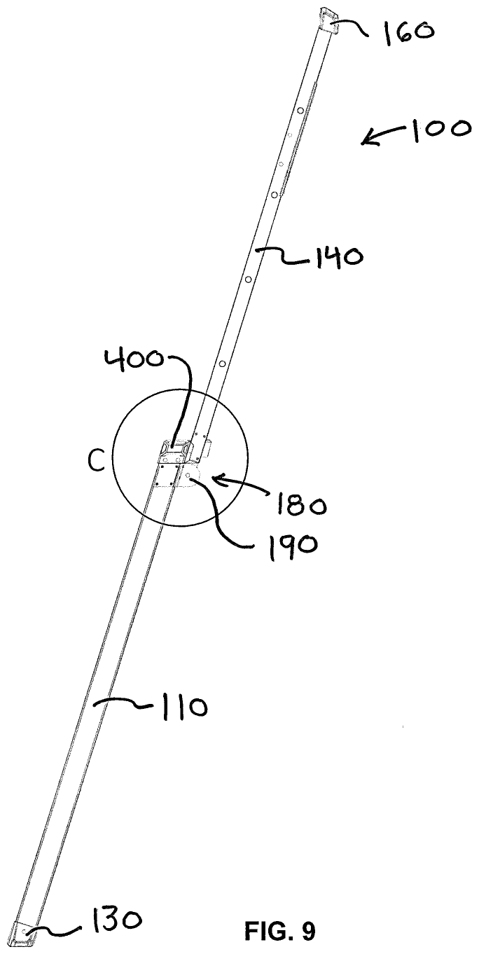

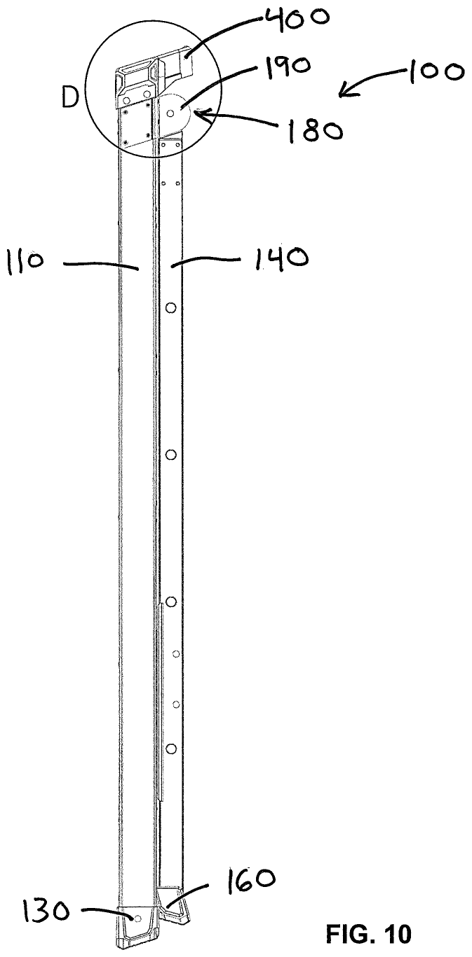

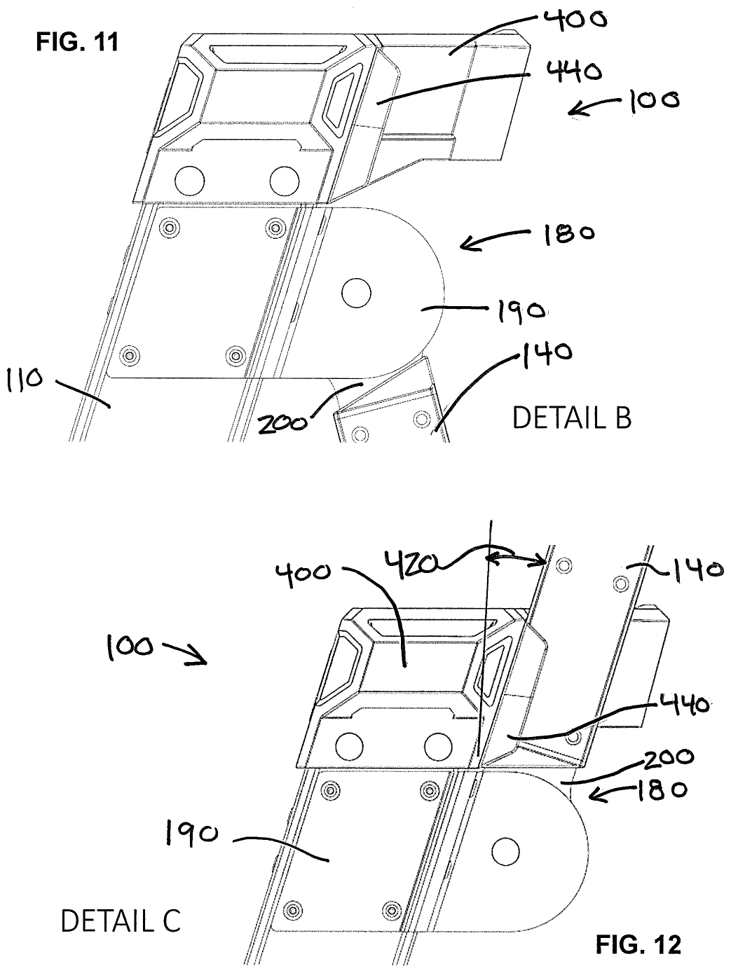

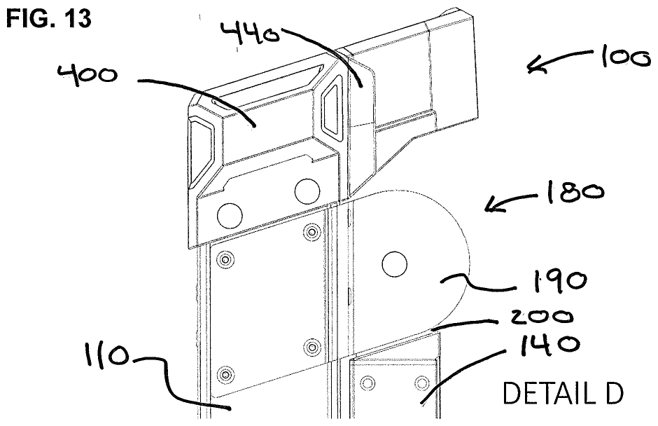

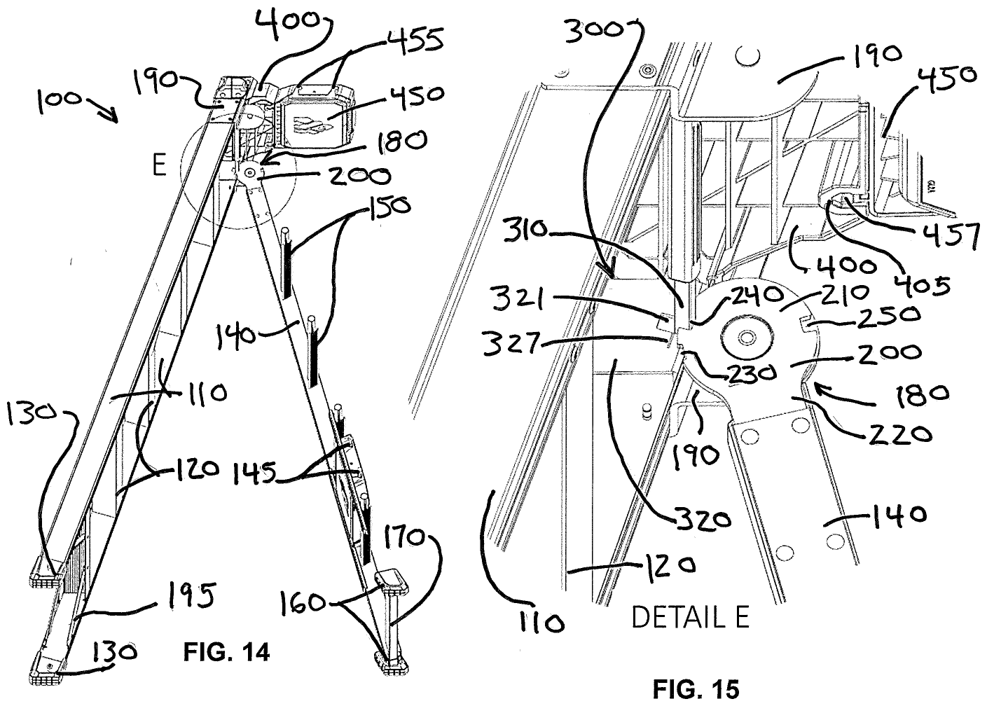

The combination ladder 100 of the present is changeable between three positions: A-frame as illustrated in FIGS. 4, 8, and 11; extension as illustrated in FIGS. 9 and 12; and folded as illustrated in FIGS. 10 and 13. The combination ladder 100 can be locked in any of these positions by novel hinges 180 and hinge latch mechanisms 300. The preferred embodiment of the present invention has the top cap upper surface 402 being parallel to the surface upon which the combination ladder 100 is resting when in the A-frame position.

In one embodiment, the hinge 180 is comprised of a front hinge plate 190 and a rear hinge plate 200. Preferably each front hinge plate 190 is fixed to a respective front rail 110 and each rear hinge plate 200 is attached to a respective rear rail 140 and rotatable with respect to the front hinge plate 190. As illustrated in FIG. 4, the front hinge plates 190 are preferably mounted abutting or near the top cap 400. This arrangement provides the longest reach when the combination ladder is in its extension position (FIG. 9). The rear hinge plate 200 includes a body 210 and head 220 that includes a folded notch 230, an A-frame notch 240, and an extension notch 250.

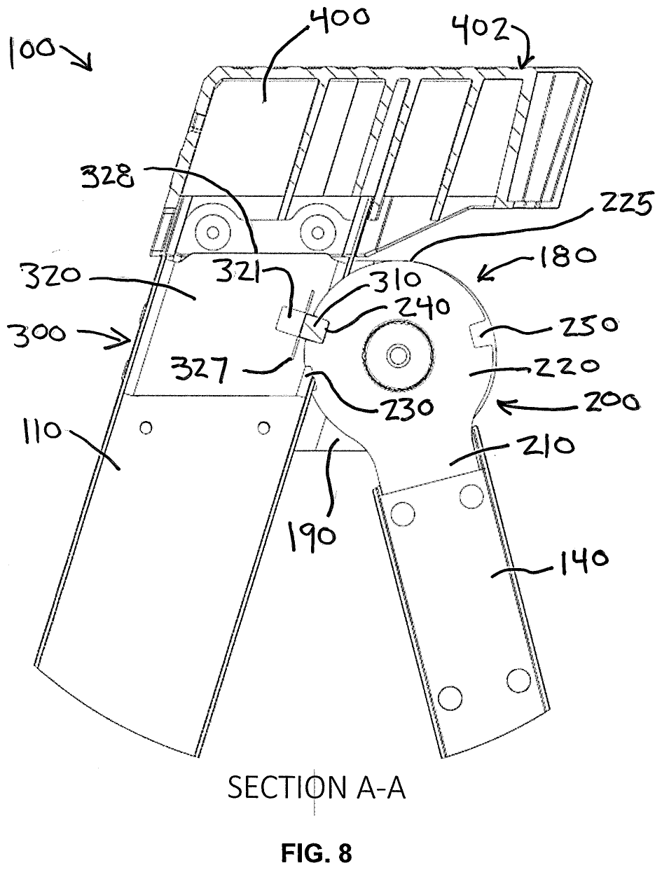

FIG. 8 provides a detailed view of the rear hinge plate 200 relationship to the front hinge plate 190 as well as the hinge latch mechanism 300. With reference to FIG. 21, each hinge latch mechanism 300 is comprised of a latch bar guide 320, a latch spring 330, a latch spring coupler, 340 and a latch spring guide 350. The pair of hinge latch mechanisms 300 share a single latch bar 310 for locking and unlocking both hinges 180 simultaneously. The latch bar 310 has a front face 311, rear face 312, top face 313, and bottom face 314. The latch bar 310 preferably has a grip 315 made of polypropylene, rubber, or other suitable material to improve grip on the latch bar 310 as well as providing user comfort. The hinge latch mechanism 300 locks into one of the three positions (folded, A-frame, or extension) when the latch bar 310 extends into the folded notch 230, A-frame notch 240, or extension notch 250, respectively. Preferably each latch bar guide 320 rests within its respective front rail 110 to both protect the latch mechanism 300 from damage and to protect a user of the combination ladder from pinch points.

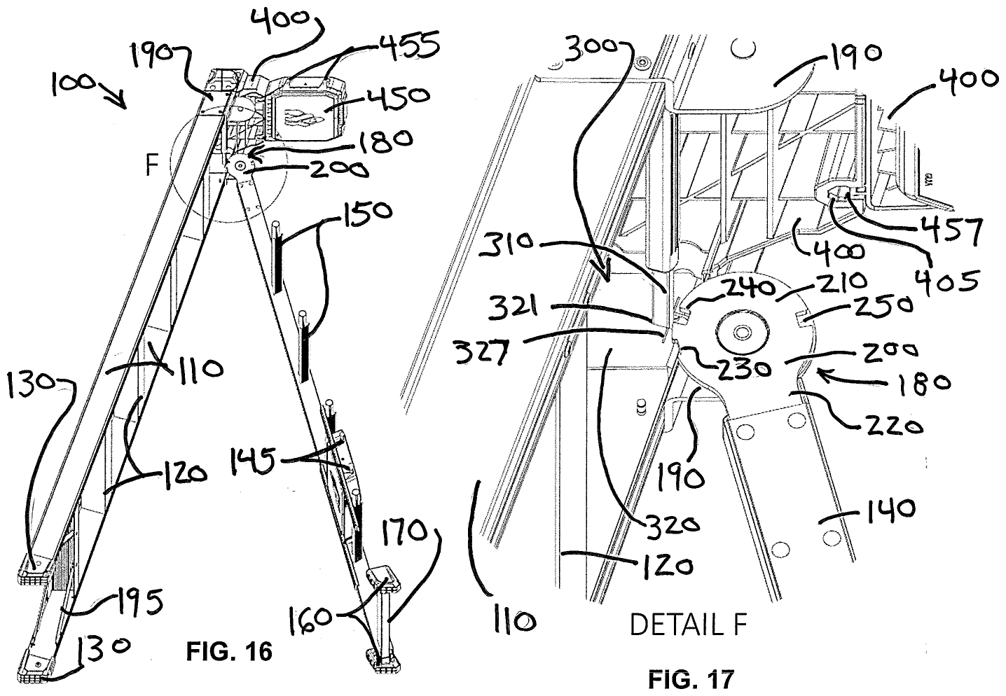

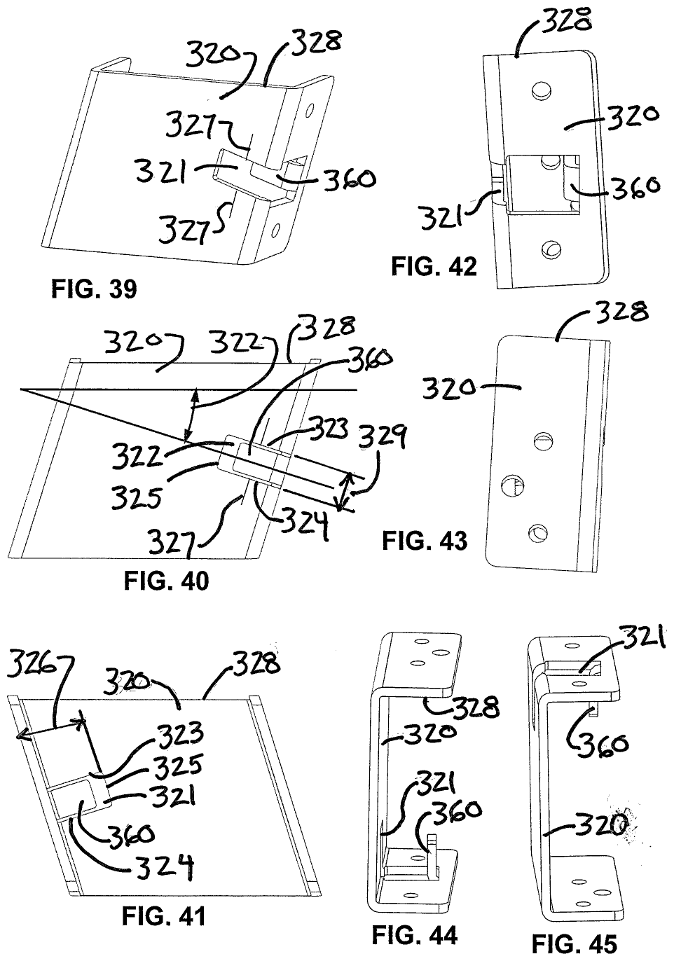

Each latch bar guide 320 has a top edge 328 that is preferably parallel to the top cap upper surface 402 and has a guide slot 321 along which the latch bar 310 may move to lock and unlock the hinges 180. As shown in FIGS. 39-45, the latch bar slot 321 forms a latch bar slot angle 322 in relation to the latch guide bar top edge 328 to enhance the latch bar 310 being biased to a locked position and to improve the ergonomic use of the latch bar 310 to lock and unlock the combination ladder 100. The preferred latch slot angle 322 is about 5-30 degrees with an optimum angle of 17.5 degrees. The latch bar 310 extends through the latch bar guides 320 on each hinge 180 and is maintained within the latch bar guides 320 by latch bar guide tabs 360. The latch bar slot 321 has a top face 323, bottom face 324, rear face 325, depth 326, and height 329. Movement of the latch bar 310 is controlled by these faces 232, 324, 325 as the latch bar 310 is dimensioned with a latch bar depth 317 and latch bar height 318 to fit securely in the latch slot 321 and allow movement from the rear face 325 either into one of the folded notch 230, A-frame notch 240, or extension notch 250 of each hinge 180 or presses against the rear hinge plate outer radius 225. The latch bar guide slot height 329 is preferably about 5 percent larger than the latch bar height 318. Each latch bar guide 320 preferably has an indicator 327 that provides a visual indication of whether the latch bar 310 is a locked (see FIG. 15) or unlocked position (see FIG. 17). For the preferred embodiment, the latch bar guide depth 326 is approximately twice the latch bar depth 317 with the latch bar guide indicator 327 at approximately half the latch bar guide depth 326. Another indicator of the latch bar 310 being in the locked position is provided by coloring the latch spring coupler 340, preferably green, that can be seen through the latch bar guide slot 321.

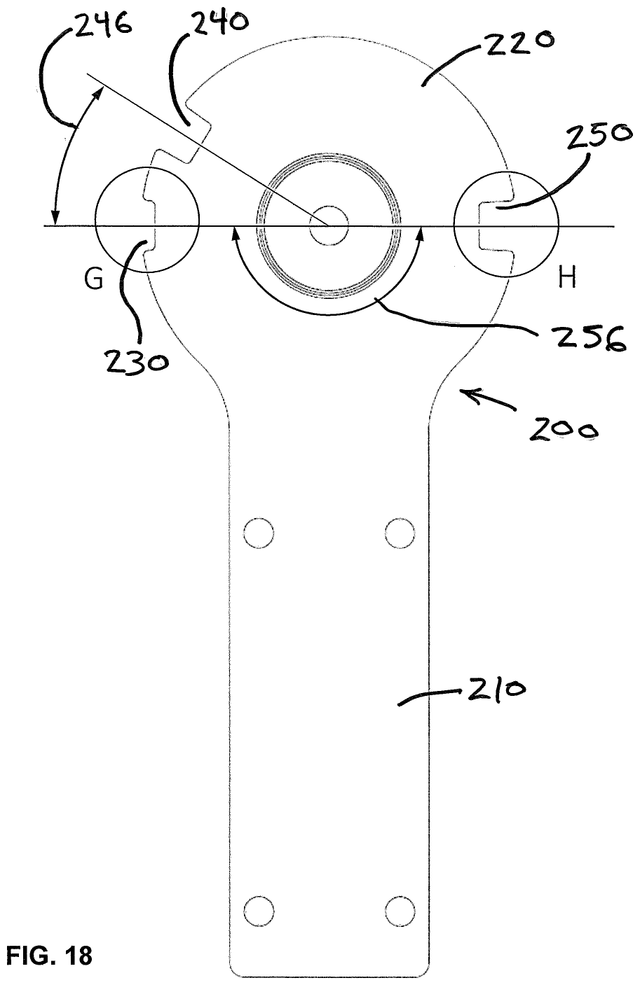

In a further embodiment, the notches 230, 240, 250 of the present invention has an A-frame notch depth 243 and extension notch depth 253 that are deeper than that of the folded notch depth 233. This arrangement better secures the combination ladder 100 when in the use position than the stored position while making it easier for a user to move the ladder out of the stored position. The preferred depth of the A-frame notch depth 243 and extension notch depth 253 is approximately 75 percent of the latch bar depth 317 and the preferred depth of the folded notch depth is 25 percent of the latch bar depth 317. However, it is contemplated that the 230, 240, 250 could all be of the same depth and could even be 100 percent of the latch bar depth 317. FIG. 18 depicts the preferred arrangement of the notches 230, 240, 250. The preferred embodiment has the A-frame notch position 246 that is between 25 and 40 degrees displaced from the folded notch position 236, with the optimal angle of 32 degrees. The preferred embodiment has an extension notch position 256 that is 180 degrees from the folded notch position 236 to have the rear set of rails 140 be parallel to the front rails 110 when the combination ladder 100 in extension position.

In another embodiment illustrated by FIGS. 19-20, the notches 230, 240, 250 are wedged to allow the latch bar 310 to enter notches 230, 240, 250 more readily as the hinge 170 is rotated in either direction. The wedge angles 235, 255 are preferably 5-8 degrees and centered on each notch 230, 240, 250. The outer width of the notches 234, 254 is preferably about 5 percent of the latch bar height 318. Another aspect to improve the functionality of the hinge latch mechanism 300 is to have external fillets 237, 257 to allow the latch bar 310 to move into the notches more easily 230, 240, 250 as well as eliminate sharp corners for user safety. Internal fillets 238, 258 are also provided to eliminate stress points on inner corners of the notches 230, 240, 250 and to accommodate external fillets 319 on the latch bar 310. The preferred size of the fillets 237, 238, 257, 258, 319 are preferably about 10 percent of the latch bar depth 317 or latch bar height 318. The notches 230, 240, 250 are configured to allow the latch bar 310 to rest within the notches 230, 240, 250 with the latch bar rear face 312 resting against the notch bottom 231, 241, 251 into which the latch bar 310 is inserted.

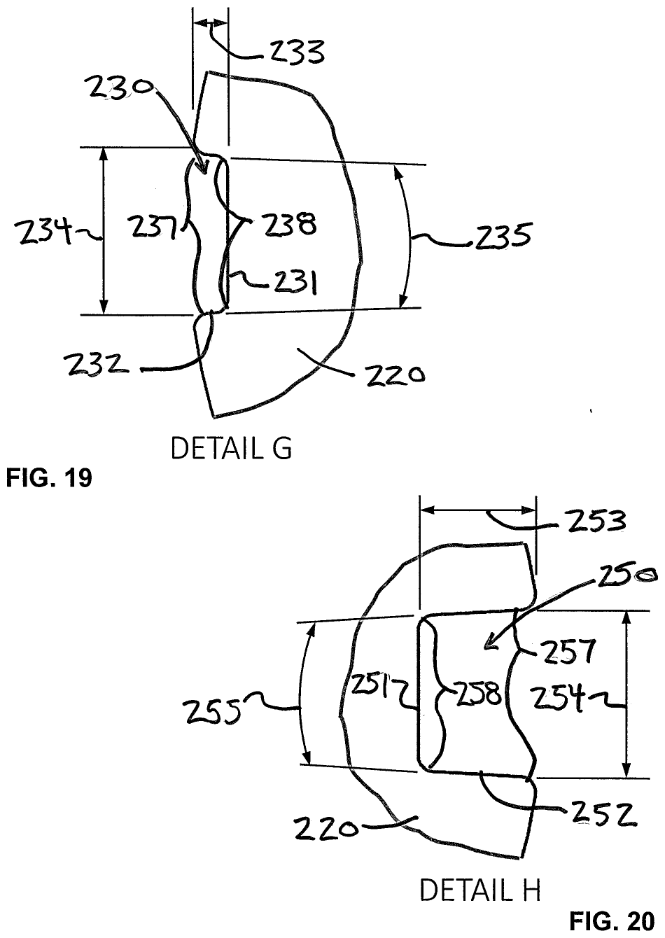

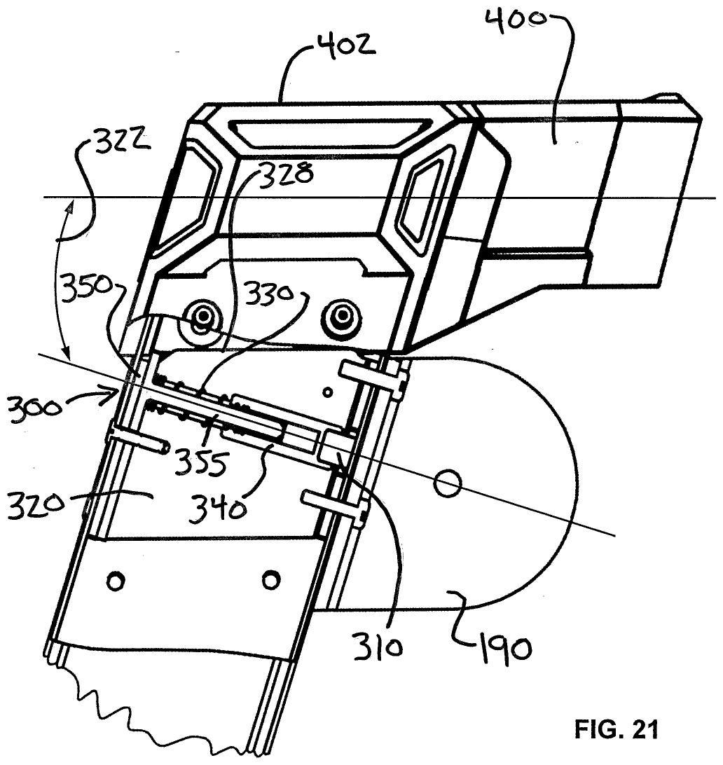

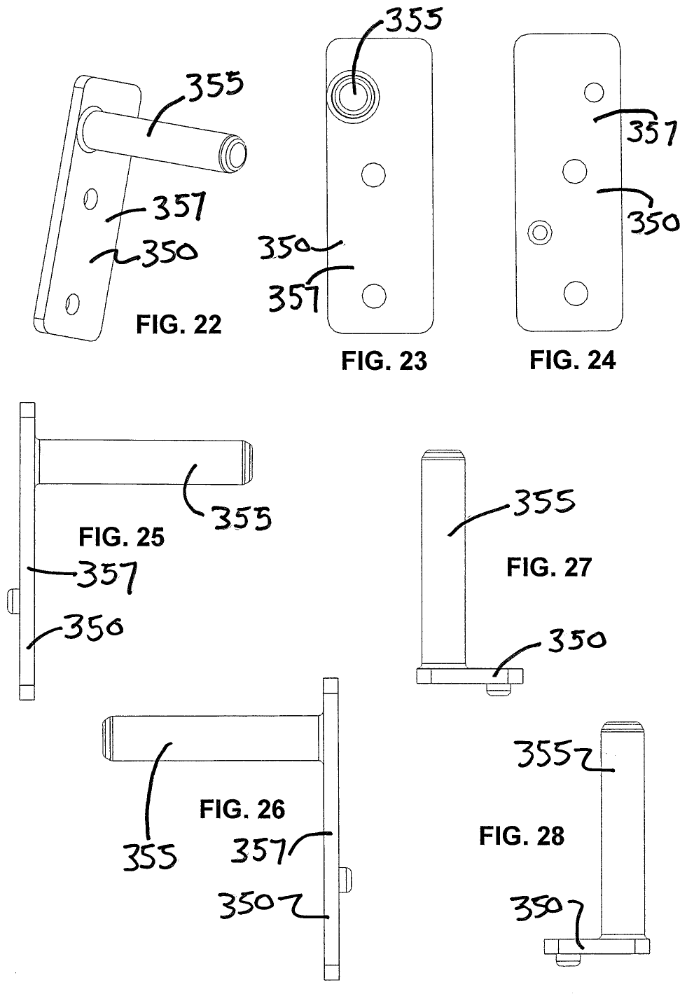

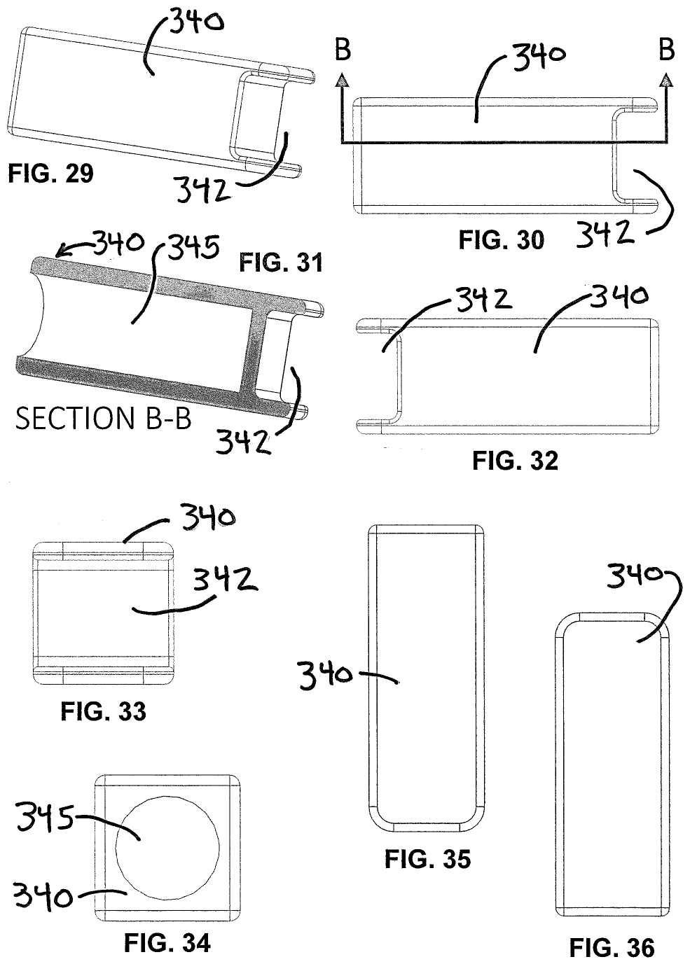

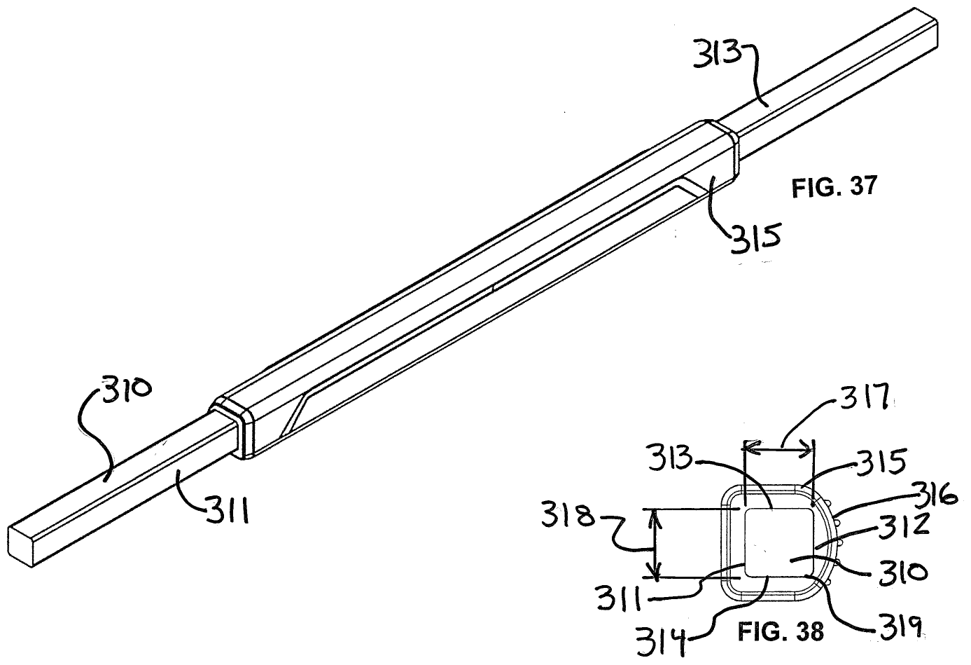

As illustrated in FIG. 21, the latch bar mechanism 310 further includes a latch spring 330, latch spring coupler 340 having a latch receiver 342 and channel 345 (see FIG. 31), and a latch spring guide 350 having a guide shaft 355 (see FIG. 22). These elements function with the latch bar guide 320 to control the movement of the latch bar 310 to lock and unlock the pair of hinges 180. The latch spring coupler 340 acts to functionally connect the latch spring 330 to the latch bar 310. The latch spring coupler 340 (best viewed in FIGS. 29-36) is preferably made of polyoxymethylene for its strength and light weight, but can be manufactured of nylon, other plastics, or even metal. The coupler 340 has a latch receiver 342 into which the latch bar 310 fits and a channel 345 that is sized to accept the latch spring guide shaft 355. The latch spring guide shaft 355 is sized to loosely fit within the latch spring 330 and latch spring coupler channel 345 to allow the latch spring coupler 340 to freely move; thus, allowing the latch bar 310 to move within the latch bar guide slot 321.

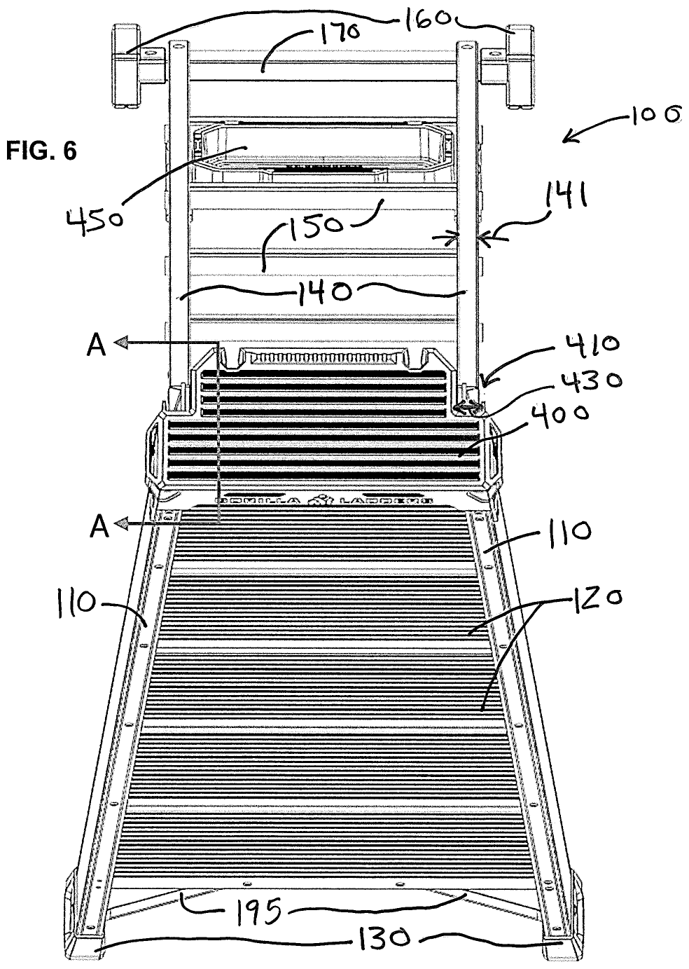

As noted above, a key feature of the present invention is the location of the hinge 180 to the top cap 400. By having the hinge 180 located adjacent to or abutting (preferably), the combination ladder 100 has a longer length in the extension position than conventional 2-in-1 ladders. Other aspects of the present invention improve the performance of the combination ladder 100 when in the extension position. As depicted in FIGS. 6 and 12, the top cap 400 includes a rear rail receiver 410 having a receiver angle 420, receiver width 430, and receiver tab 440. The receiver tab 440 is arranged to provide a receiver width 430 to hold the rear rail 140 when the combination ladder 100 is in the extension position (i.e., the receiver width 430 is nominally wider than the rear rail width 141). Preferably, the receiver width 430 is such that the rear rail 140 snaps into the receiver 410 to improve the hinge latch mechanism 300 in locking the combination ladder 100 in the extension position. Another aspect of the invention is that the latch receiver 410 has a receiver angle 420 that allows the ladder rear rail 140 to be parallel to the front rail 110 when the ladder is in the extension position.

It is contemplated that features disclosed in this application, as well as those described in the above applications incorporated by reference, can be mixed and matched to suit particular circumstances. Various other modifications and changes will be apparent to those of ordinary skill.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A combination ladder comprising:
a pair of front rails spanned by a plurality of steps;
a pair of rear rails spanned by a plurality of rungs;
a hinge mechanism for rotating the pair of front rails in relation to the pair of rear rails and locking the rails in a folded orientation, an A-frame orientation, or an extension orientation, the hinge mechanism comprising:
a latch bar;
a pair of hinges, each hinge pivotally connected a respective front rail to a respective rear rail, each hinge comprising:
a front hinge plate;
a rear hinge plate; and
a latch bar guide positioned within its respective front rail;
wherein each rear hinge plate comprises:
a folded notch;
an A-frame notch; and
an extension notch.

2. The combination ladder of claim 1 wherein each latch bar guide comprises a top edge and a latch bar guide slot.

3. The combination ladder of claim 2 wherein each latch bar guide slot and latch guide top edge define a latch bar guide slot angle between 5-30 degrees.

4. The combination ladder of claim 3 wherein the latch bar guide slot angle is 17.5 degrees.

5. The combination ladder of claim 2 wherein the latch mechanism further comprises:
a latch spring;
a latch spring guide; and
a latch spring coupler, the latch spring coupler linking the latch spring to the latch bar.

6. The combination ladder of claim 5 wherein the latch spring coupler comprises a guide channel and the latch spring guide comprises a shaft and wherein the latch spring guide shaft is at least partially disposed within the latch spring coupler guide channel.

7. The combination ladder of claim 6 wherein the latch bar guide slot comprises a rear face that defines a guide slot depth and the latch spring biases the latch bar away from the rear face.

8. The combination ladder of claim 7 wherein the latch bar has a latch bar depth and the latch bar guide slot depth is at least twice the latch bar depth.

9. The combination ladder of claim 8 wherein the latch bar guide includes a visual indicator that the latch bar is completely inserted into the A-frame notch or the extension notch.

10. The combination ladder of claim 8 wherein the latch bar comprises a latch bar grip.

11. The combination ladder of claim 10 wherein the latch bar is moved by directly pulling on the latch bar or latch bar grip.

12. The combination ladder of claim 1 further comprising a top cap wherein the hinge mechanism is adjacent to the top cap.

13. A combination ladder comprising:
a pair of front rails spanned by a plurality of steps;
a pair of rear rails spanned by a plurality of rungs;
a hinge mechanism for rotating the pair of front rails in relation to the pair of rear rails and locking the rails in a folded orientation, an A-frame orientation, or an extension orientation, the hinge mechanism comprising:
a latch bar having a latch bar grip;
a pair of hinges, each hinge pivotally connected a respective front rail to a respective rear rail, each hinge comprising a latch bar guide positioned within its respective front rail, each latch bar guide comprising:
a latch spring;
a latch spring guide;
a latch spring coupler, the latch spring coupler linking the latch spring to the latch bar; and
a latch bar guide slot.

14. The combination ladder of claim 13 wherein the latch spring coupler comprises a guide channel and the latch spring guide comprises a shaft and wherein the latch spring guide shaft is at least partially disposed within the latch spring coupler guide channel.

15. The combination ladder of claim 14 wherein the latch bar guide slot comprises a rear face that defines a guide slot depth and the latch spring biases the latch bar away from the rear face.

16. The combination ladder of claim 15 wherein the latch bar is moved by directly pulling on the latch bar or latch bar grip.

17. The combination ladder of claim 16 wherein the hinge mechanism is adjacent to the top cap.

18. A hinge mechanism for a combination ladder comprising:
a latch bar;
a pair of hinges functionally coupled by the latch bar, each hinge comprising:
a front hinge plate;
a rear hinge plate; and
a latch bar guide having a latch bar guide slot;
wherein each rear hinge plate comprises:
a folded notch;
an A-frame notch; and
an extension notch;
wherein the latch bar is moveable within the latch bar guide slot from a position within one of the folded notch, A-frame notch, or folded notch to outside of any of the notches.

19. The hinge mechanism for a combination ladder of claim 18 wherein each latch bar guide further comprises:
a latch spring;
a latch spring guide;
a latch spring coupler, the latch spring coupler linking the latch spring to the latch bar.

20. The hinge mechanism for a combination ladder of claim 19 wherein the latch spring coupler comprises a guide channel and the latch spring guide comprises a shaft and wherein the latch spring guide shaft is at least partially disposed within the latch spring coupler guide channel.
